(19) United States
(12) Patent Application Publication
(10) Pub. No.: US 2003/0165235 A1
(43) Pub. Date: Sep. 4, 2003

(54) Sharing high-frequency band of neighboring phone lines

(76) Inventors: Amir Gholam Aghdam, Toronto (CA); Edward Joseph Davison, North York (CA)

Correspondence Address: Edward J. Davison, 165 Banbury Road, North York, ON, M3B 2L7, CA

(21) Appl. No.: 10/084,957

(22) Filed: Mar. 1, 2002

(51) Int. Cl. H04M 1/76; H04M 9/00

(52) U.S. Cl. 379/414

(57) ABSTRACT

The present invention provides a method to reduce the crosstalk between lines assigned to a digital subscriber line (DSL) service or fat-pipe, which will then improve the signal to noise ratio (SNR) and the line reach. It can also be used to assign multiple lines to a fat-pipe, where the number of available to a fat-pipe customer is not enough for the corresponding service. The service performance can be improved through interference management by identifying those lines that are not strongly coupled, and thence assigning them to DSL service or fat-pipe, instead of using lines that are already assigned to the plain old telephone service and fat-pipe. The number of available lines for the fat-pipe customers can be increased by using lines that have already been assigned to plain old telephone service (POTS) customers, but which are not used for data transmission (DSL or fat-pipe service). When a POTS customer's line is to be used for another customer's DSL or fat-pipe service, it is required to use a low-pass filter on the POTS customer's line to prevent him/her from having access to the DSL or fat-pipe customer's data, and a high-pass filter on the DSL or fat-pipe customer's line to prevent him/her from having access to the voice signal on the line.

### CROSS-REFERENCE TO RELATED APPLICATIONS

Not Applicable

### BACKGROUND OF THE INVENTION

Phone lines have primarily been used for transmitting voice signal (plain old telephone service or POTS signal), but recently have been deployed for high-speed data communication through digital subscriber line (DSL) technology. DSL service is deployed upon the customer's request, which in fact uses the high-frequency band of the phone line that is not interacting with the voice band. The idea of fat-pipe technology has been recently proposed to deploy multiple lines for one customer to achieve a higher transmission speed. However, in general, multiple lines may not be available to a customer, as the phone lines coining to the neighborhood of a particular customer may have already been assigned to other customers. Many of these customers whose lines are accessible at different locations through bridged-taps do not have DSL services and only use their phone lines for POTS signal. Therefore, the central office can provide DSL service to several customers through telephone lines that have already been assigned to other customers for ordinary phone service and which are accessible in specific locations. On the other hand, by identifying the crosscoupling strength between different lines and thence assigning lines with minimum interaction to the DSL service (independent of the existing plain old telephone service lines), will result in a better interference management and a better service performance. In order to guarantee a secure signal transmission, a low-pass filter and a high-pass filter are required to be connected to these lines that are shared by two customers, which then prevent each customer from having access to the other customer's signal.

### BRIEF SUMMARY OF THE INVENTION

This invention enables the DSL service providers to provide high-speed DSL service for customers through telephone lines that are deployed to only transmit POTS signal for other users. The proposed method can be used to deploy lines for fat-pipe technology, and can also be used for better interference management by deploying DSL services on telephone lines that are not strongly coupled and assigning such lines to different customers, regardless of their regular phone line.

### BRIEF DESCRIPTION OF THE FIGURES

FIG. 1(a) shows an ideal low-pass filter to stop the broad-band signal. FIG. 1(b) gives an ideal high-pass filter to stop the voice-band signal.

FIG. 2 illustrates line assignment for a fat-pipe by sharing other customers' lines discussed in Example 1. Customer #1 has a fat-pipe service consisting of line #1, a high-pass filtered line #3, and a high-pass filtered line #4. Customer #2 has POTS service. Customer #3 and Customer #4 have POTS service through the low-pass filtered line #3 and low-pass filtered line #4 respectively. They both share their lines with customer #1.

FIG. 3 illustrates line assignment for DSL services, using the phone lines of other POTS customers, in order to minimize crosscoupling between the DSL services, as discussed in Example 2. Customer #1 has POTS service through the low-pass filtered line #1. Customer #2 has DSL service through line #2. Customer #3 has DSL service through the high-pass filtered line #1 and shares the line with customer #1. Line #3 provides POTS for customer #3.

FIG. 4 illustrates the optimal assignment of lines to 3 DSL customers in a neighborhood, as discussed in Example 3.

FIG. 5 gives the downstream SNR with optimal line assignment given by (a), (b), (c), and without optimal line assignment given by (d), (e), (f), for Example 3. The vertical axis is SNR in dB and the horizontal axis is frequency in KHz.

### DETAILED DESCRIPTION OF THE INVENTION

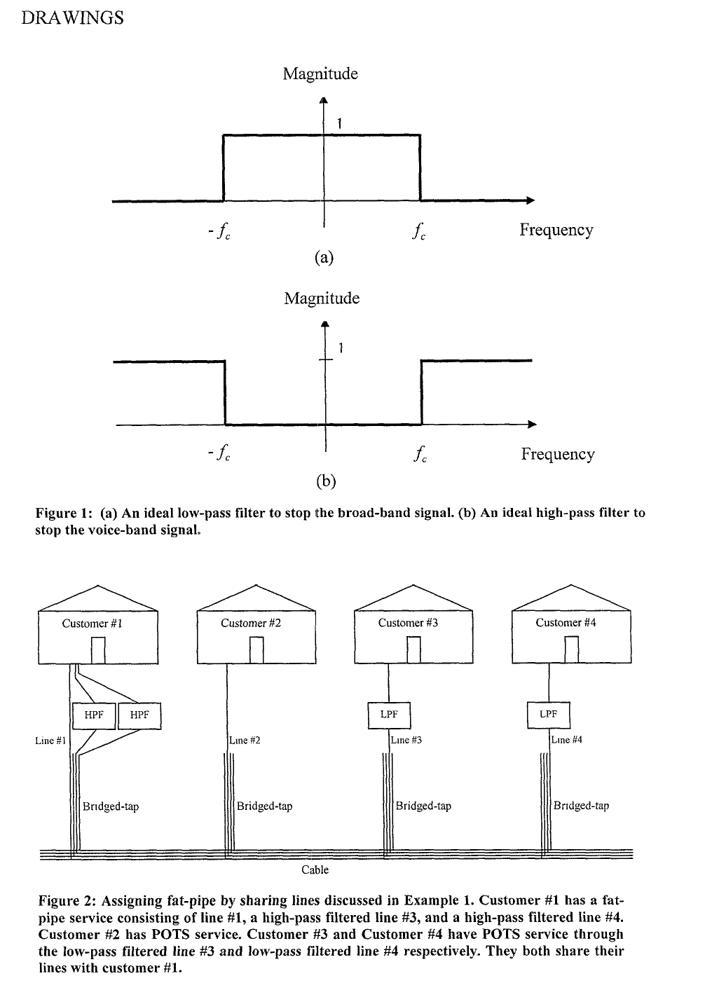

One of the future directions of digital subscriber line (DSL) networks is fat-pipe technology, where more than one telephone line is utilized to a customer to provide faster data transmission. If this technology obtains attention and starts to grow, one potential limiting problem would be the number of available lines. On the other hand, there are a lot of customers who are only using voice-band communication and there is a potential resource (high frequency band) on the corresponding line, which is not being used. A method is proposed so that one may use a bunch of lines in the fat-pipe transmission through the bridged-taps, some of which may have been used by other customers for low-frequency band voice or plain old telephone service (POTS) signal. Using suitable filters, one low-stop filter in the fat-pipe customer's line, and one high-stop filter in the POTS signal customer's line, to provide security for both customers, one can take advantage of the lines that are not being used by the telephone customers. This will provide an optimal usage of the frequency resources of the telephone lines, when necessary. This technique will require a low-pass filter and a high-pass filter to be installed on each shared line. The low-pass filter should be placed on the line where it reaches the customer that is assigned for the POTS signal, and the high-pass filter should be placed on the line where it reaches the customer that is assigned for the DSL signal. The high-pass filter should stop the frequency components outside the DSL frequency band (usually above 10 KHz) and will provide security for POTS signal customer by preventing the DSL customer who is using the same line, from having access to the low-frequency POTS signal. The low-pass filter should stop the frequency components higher than the voice-band and will similarly provide security for the DSL customer by preventing the POTS signal customer from having access to the high-speed digital data. The filters must be activated if a line is shared between DSL and POTS signal customers. The ideal low-pass and high-pass filters for this purpose are given in FIGS. 1(a) and (b) respectively. The cutoff frequency f_{c} can be anything between the maximum voice frequency band (around 4 KHz) and minimum data frequency band (it varies for different DSL service types and is usually above 10 KHz). In practice, one can use realizable filters such as Butterworth or Chebychev filters.

This method can also be used to improve the quality of the received signal by assigning the DSL service and telephone service through different lines. In other words one can optimally assign the DSL service independently from the line that has already been assigned for the customer's regular phone service. The following example illustrates how this can improve the quality of the DSL service in a neighborhood.

Example 1: Consider the customers shown in FIG. 2. Assume that customer #1 would like to improve the performance of his DSL service through a fat-pipe consisting of three lines. Assume also that lines #2, #3 and #4 are accessible for this customer through the bridged-tap (in the real world there are several lines accessible through the bridged-taps) but that none of these lines are idle. In other words, other customers are using all accessible lines for this customer. Assuming that some of these accessible lines are assigned for POTS signal, and that no DSL service is given to the corresponding customers, the DSL customer can use some of these lines to provide a fat-pipe type of DSL service for faster data transmission. If there are several lines accessible for DSL service, one can choose the lines with minimum interaction to minimize the interference between the lines. The choice of lines can also be made based on minimizing the interaction between the fat-pipe lines and the lines that have already been assigned for DSL service in the neighborhood. The interaction between different lines can be identified through various tests or trouble reports. In this example, assume that line #2 has strong crosscoupling with lines #1, #3, #4 and/or the existing DSL lines in the neighborhood. In this case, the best choice for the fat-pipe lines would be line #1, #3 and #4. After the fat-pipe lines are chosen, the high-pass and low-pass filters must be used to protect the security of the customers by preventing others from having access to their signal. All shared lines that are included in the fat-pipe must go through a high-pass filter in the fat-pipe customer's end and through a low-pass filter in the POTS signal customers' end. In this example, lines #3 and #4 will have high-pass filters in customer #1's end, and will have low-pass filters at customer #3 and customer #4's end, as shown in the figure.

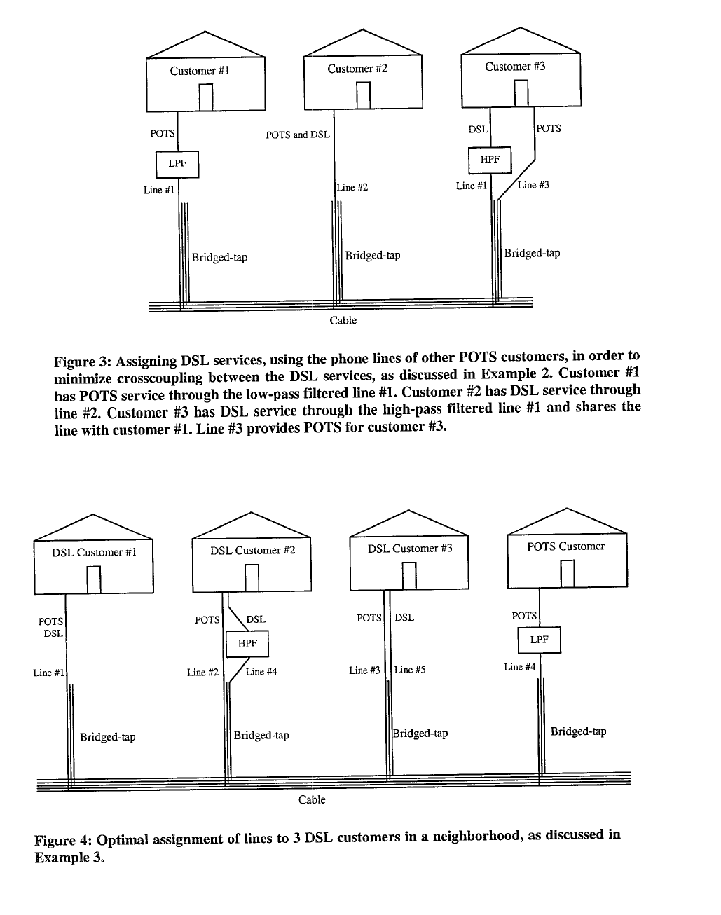

Example 2: Consider three customers in a neighborhood shown in FIG. 3. Customer #1 has only the regular phone service while customer #2 and customer #3 both have DSL service as well. Due to the strong crosscoupling between line #2 and line #3 which are assigned for customer #2 and customer #3 respectively, the SNR of the signal on these two lines are significantly low, which can also affect the data-rate that is assigned for these lines. Assume also that the crosscoupling between line #1 and line #2 is very weak and that line #1 is available for customer #3 through a bridged-tap. This means that by assigning line #1 for the DSL service of customer #3, the crosstalk interference between the DSL services of customer #2 and customer #3 will drop significantly, which will improve the SNR of the transmitted and received signals for both customers. To achieve this in a secure manner, a low-pass filter is required to be set on line #1 at point A, where the POTS signal is delivered to customer #1, and a high-pass filter is required to be set on the same line at point B, where the broad-band signal is delivered to customer #3. This will assure customers that their signal will not be accessible by another customer. In other words, the POTS signal going to customer #1 will be filtered out from customer #3 using the high-pass filter, and the digital data transferred to customer #3 will be removed from the signal going to customer #1, using the low-pass filter.

One can optimize the performance by defining a performance index which can be minimized. This is shown in the next example.

Example 3: Consider a system consisting of one POTS customer and three DSL customers (who are in fact POTS customers as well) in a neighborhood shown in FIG. 4, with the following line availability through bridged-taps:

Lines #1, 2, 3 are available to DSL customer #1 and, line #1 provides POTS for this customer.

Lines #2, 3, 4 are available to DSL customer #2 and, line #2 provides POTS for this customer.

Lines #3, 4, 5 are available to DSL customer #3 and, line #3 provides POTS fro this customer.

Lines #1, 4, 5 are available to the POTS customer and, line #4 provides POTS for this customer.

Assume also that the following near end crosstalk (NEXT) transfer function matrix at customer premise equipment (CPE) side, between all 5 lines, at the point where the corresponding bridged-taps for these customers are located, is given as follows:

$${N}_{D} = [ \begin{matrix}0 & 2.3 {N}_{0} & 1.4 {N}_{0} & 0.3 {N}_{0} & 0.1 {N}_{0} \\ 2.3 {N}_{0} & 0 & 1.8 {N}_{0} & 0.8 {N}_{0} & 0.4 {N}_{0} \\ 1.4 {N}_{0} & 1.8 {N}_{0} & 0 & 0.2 {N}_{0} & 0.5 {N}_{0} \\ 0.3 {N}_{0} & 0.8 {N}_{0} & 0.2 {N}_{0} & 0 & 0.7 {N}_{0} \\ 0.1 {N}_{0} & 0.4 {N}_{0} & 0.5 {N}_{0} & 0.7 {N}_{0} & 0\end{matrix} ] ,$$

where:

|N₀|²:=10⁻¹⁵×f^{1.5},

and f denotes frequency (Hz). It is to be noted that in practice, NEXT transfer functions contain zeros or points where the magnitude drops sharply, but for simplicity and without loss of generality, we have considered the structure given in the above matrix. For this simple example, there are 10 possible ways to assign the lines to the DSL customers, which are given as follows:

Case 1: Lines #1, 2, 3 are assigned to the DSL service of customers #1, 2, 3, respectively.

Case 2: Lines #1, 2, 4 are assigned to the DSL service of customers #1, 2, 3, respectively.

Case 3: Lines #1, 2, 5 are assigned to the DSL service of customers #1, 2, 3, respectively.

Case 4: Lines #1, 3, 4 are assigned to the DSL service of customers #1, 2, 3, respectively.

Case 5: Lines #1, 3, 5 are assigned to the DSL service of customers #1, 2, 3, respectively.

Case 6: Lines #I, 4, 5 are assigned to the DSL service of customers #1, 2, 3, respectively.

Case 7: Lines #2, 3, 4 are assigned to the DSL service of customers #1, 2, 3, respectively.

Case 8: Lines #2, 3, 5 are assigned to the DSL service of customers #1, 2, 3, respectively.

Case 9: Lines #2, 4, 5 are assigned to the DSL service of customers #1, 2, 3, respectively.

Case 10: Lines #3, 4, 5 are assigned to the DSL service of customers #1, 2, 3, respectively.

Remark 1: There are 4 other cases, which are in fact equivalent to some of the cases above, since the order in which the lines are assigned to the customers is not relevant. For example, assigning lines #1, 4, 3 to DSL customers #1, 2, 3 is similar to Case 4, assigning lines #2, 4, 3 or #3, 2, 4 to the DSL services is similar to Case 7, and assigning lines #3, 2, 5 to the DSL services is similar to Case 8.

To guarantee a secure signal transmission, a high-pass and a low-pass filter are required for the lines in all cases, except for Case 1, where the POTS and DSL service are provided through the same transmission line.

Assume now that the following minimization problem is to be solved:

$${min}_{{l}_{1} , {l}_{2} , {l}_{3}} \{ {\int }_{0}^{∞} ( {K}_{DN} \cdot {U}_{DSL , UP}^{*} ( f ) \cdot {N}_{DSL , DN}^{*} \cdot ( f ) \cdot {W}_{DN} ( f ) \cdot {N}_{DN} ( f ) \cdot {U}_{DSL , UP} ( f ) + {K}_{UP} \cdot {U}_{DSL , DN}^{*} ( f ) \cdot {N}_{DSL , UP}^{*} \cdot ( f ) \cdot {W}_{UP} ( f ) \cdot {N}_{UP} ( f ) \cdot {U}_{DSL , DN} ( f ) ) df \} , \qquad ( 1 )$$

where l₁ε{1,2,3}, l₂ ε{2,3,4}, l_{3 ε{}3,4,5} denote the line assigned to DSL customers #1, 2, 3 respectively and lᵢ≠lⱼ for distinct values of i, j. The supscript * denotes conjugate transpose of the matrix. U_{DSL,UP} and U_{DSL,DN} represent the transmitted DSL signals in the upstream and downstream directions respectively as follows:

$${U}_{DSL , UP} \text{:} = [ \begin{matrix}{U}_{DSL , UP , 1} \\ {U}_{DSL , UP , 2} \\ {U}_{DSL , UP , 3}\end{matrix} ] , {U}_{DSL , DN} \text{:} = [ \begin{matrix}{U}_{DSL , DN , 1} \\ {U}_{DSL , DN , 2} \\ {U}_{DSL , DN , 3}\end{matrix} ] ,$$

and N_{DSL,UP} and N_{DSL,DN} represent the NEXT transfer matrix between lines assigned to DSL customers in the upstream (central office or CO side) and downstream (CPE side) directions respectively, as follows:

$${N}_{DSL , UP} \text{:} = [ \begin{matrix}0 & {N}_{UP} ( {l}_{1} , {l}_{2} ) & {N}_{UP} ( {l}_{1} , {l}_{3} ) \\ {N}_{UP} ( {l}_{2} , {l}_{1} ) & 0 & {N}_{UP} ( {l}_{2} , {l}_{3} ) \\ {N}_{UP} ( {l}_{3} , {l}_{1} ) & {N}_{UP} ( {l}_{3} , {l}_{2} ) & 0\end{matrix} ] , \\ {N}_{DSL , DN} \text{:} = [ \begin{matrix}0 & {N}_{DN} ( {l}_{1} , {l}_{2} ) & {N}_{DN} ( {l}_{1} , {l}_{3} ) \\ {N}_{DN} ( {l}_{2} , {l}_{1} ) & 0 & {N}_{DN} ( {l}_{2} , {l}_{3} ) \\ {N}_{DN} ( {l}_{3} , {l}_{1} ) & {N}_{DN} ( {l}_{3} , {l}_{2} ) & 0\end{matrix} ] ,$$

In this case, the terms W_{UP}(f) and W_{DN}(f) represent a weighting matrix which can be used to prioritize different DSL customers if necessary, and K_{UP} and K_{DN} represent the relative importance of crosscoupling in the upstream and downstream directions respectively. It is to be noted that the terms N_{DN}(f).U_{DSL,UP}(f) and N_{UP}(f).U_{DSL,DN}(f) represent crosscoupling noise in the downstream and upstream directions respectively. This implies that the integrand in the performance index is the weighted crosscoupling power in the DSL network. Assume now that for this example K_{DN}=1, K_{UP}=0 and that W_{DN}(f) is a 3×3 identity matrix between f₁=4 KHz and f₂=80 KHz, and zero elsewhere. This implies that we are only concerned with downstream cross-coupling and that all lines are equally weighted in terms of cross-coupling noise. Assume also that all DSL customers have basic access DSL, where the transmitted signal power is given by:

$${\vert {U}_{DSL , UP , 1} \vert}^{2} = {\vert {U}_{DSL , UP , 2} \vert}^{2} = {\vert {U}_{DSL , UP , 3} \vert}^{2} = \frac{5 \times {2.5}^{2}}{9 \times 135} \times \frac{2}{80000} \times {( \frac{sin ( π \frac{f}{80000} )}{π \frac{f}{80000}} )}^{2} \times \frac{1}{1 + {( \frac{f}{80000} )}^{4}}$$

where f denotes the frequency in Hz. In this case, the minimization problem (1) can be simplified to become:

$${min}_{q} \{ {\int }_{4000}^{80000} {C}_{q} {\vert {U}_{DSL , UP , 1} ( f ) \cdot {N}_{0} \cdot ( f ) \vert}^{2} ⅆ f \} ,$$

where the index q=1, . . . , 10 corresponds to the previous listed 10 different possible cases which arises for this example. In this case, the values of C₁ to C₁₀, can be determined to be given by:

$$\begin{matrix}\text{Case 1:} {C}_{1} = {[ \begin{matrix}1 & 1 & 1\end{matrix} ] [ \begin{matrix}0 & 2.3 & 1.4 \\ 2.3 & 0 & 1.8 \\ 1.4 & 1.8 & 0\end{matrix} ]}^{2} [ \begin{matrix}1 \\ 1 \\ 1\end{matrix} ] = {( 2.3 + 1.4 )}^{2} + {( 2.3 + 1.8 )}^{2} + {( 1.4 + 1.8 )}^{2} = 40.74 \\ \text{Case 2:} {C}_{1} = {[ \begin{matrix}1 & 1 & 1\end{matrix} ] [ \begin{matrix}0 & 2.3 & 0.3 \\ 2.3 & 0 & 0.8 \\ 0.3 & 0.8 & 0\end{matrix} ]}^{2} [ \begin{matrix}1 \\ 1 \\ 1\end{matrix} ] = {( 2.3 + 0.3 )}^{2} + {( 2.3 + 0.8 )}^{2} + {( 0.3 + 0.8 )}^{2} = 17.58 \\ \text{Case 3:} {C}_{1} = {[ \begin{matrix}1 & 1 & 1\end{matrix} ] [ \begin{matrix}0 & 2.3 & 0.1 \\ 2.3 & 0 & 0.4 \\ 0.1 & 0.4 & 0\end{matrix} ]}^{2} [ \begin{matrix}1 \\ 1 \\ 1\end{matrix} ] = {( 2.3 + 0.1 )}^{2} + {( 2.3 + 0.4 )}^{2} + {( 0.1 + 0.4 )}^{2} = 13.30 \\ \text{Case 4:} {C}_{1} = {[ \begin{matrix}1 & 1 & 1\end{matrix} ] [ \begin{matrix}0 & 1.4 & 0.3 \\ 1.4 & 0 & 0.2 \\ 0.3 & 0.2 & 0\end{matrix} ]}^{2} [ \begin{matrix}1 \\ 1 \\ 1\end{matrix} ] = {( 1.4 + 0.3 )}^{2} + {( 1.4 + 0.2 )}^{2} + {( 0.3 + 0.2 )}^{2} = 5.70 \\ \text{Case 5:} {C}_{1} = {[ \begin{matrix}1 & 1 & 1\end{matrix} ] [ \begin{matrix}0 & 1.4 & 0.1 \\ 1.4 & 0 & 0.5 \\ 0.1 & 0.5 & 0\end{matrix} ]}^{2} [ \begin{matrix}1 \\ 1 \\ 1\end{matrix} ] = {( 1.4 + 0.1 )}^{2} + {( 1.4 + 0.5 )}^{2} + {( 0.1 + 0.5 )}^{2} = 6.22 \\ \text{Case 6:} {C}_{1} = {[ \begin{matrix}1 & 1 & 1\end{matrix} ] [ \begin{matrix}0 & 0.3 & 0.1 \\ 0.3 & 0 & 0.7 \\ 0.1 & 0.7 & 0\end{matrix} ]}^{2} [ \begin{matrix}1 \\ 1 \\ 1\end{matrix} ] = {( 0.3 + 0.1 )}^{2} + {( 0.3 + 0.7 )}^{2} + {( 0.1 + 0.7 )}^{2} = 1.80 \\ \text{Case 7:} {C}_{1} = {[ \begin{matrix}1 & 1 & 1\end{matrix} ] [ \begin{matrix}0 & 1.8 & 0.8 \\ 1.8 & 0 & 0.2 \\ 0.8 & 0.2 & 0\end{matrix} ]}^{2} [ \begin{matrix}1 \\ 1 \\ 1\end{matrix} ] = {( 1.8 + 0.8 )}^{2} + {( 1.8 + 0.2 )}^{2} + {( 0.8 + 0.2 )}^{2} = 11.76 \\ \text{Case 8:} {C}_{1} = {[ \begin{matrix}1 & 1 & 1\end{matrix} ] [ \begin{matrix}0 & 1.8 & 0.4 \\ 1.8 & 0 & 0.5 \\ 0.4 & 0.5 & 0\end{matrix} ]}^{2} [ \begin{matrix}1 \\ 1 \\ 1\end{matrix} ] = {( 1.8 + 0.4 )}^{2} + {( 1.8 + 0.5 )}^{2} + {( 0.4 + 0.5 )}^{2} = 10.94 \\ \text{Case 9:} {C}_{1} = {[ \begin{matrix}1 & 1 & 1\end{matrix} ] [ \begin{matrix}0 & 0.8 & 0.4 \\ 0.8 & 0 & 0.7 \\ 0.4 & 0.7 & 0\end{matrix} ]}^{2} [ \begin{matrix}1 \\ 1 \\ 1\end{matrix} ] = {( 0.8 + 0.4 )}^{2} + {( 0.8 + 0.7 )}^{2} + {( 0.4 + 0.7 )}^{2} = 4.90 \\ \text{Case 10:} {C}_{1} = {[ \begin{matrix}1 & 1 & 1\end{matrix} ] [ \begin{matrix}0 & 0.2 & 0.5 \\ 0.2 & 0 & 0.7 \\ 0.5 & 0.7 & 0\end{matrix} ]}^{2} [ \begin{matrix}1 \\ 1 \\ 1\end{matrix} ] = {( 0.2 + 0.5 )}^{2} + {( 0.2 + 0.7 )}^{2} + {( 0.5 + 0.7 )}^{2} = 2.74\end{matrix}$$

This implies that the minimum value of the performance index given by (1) for this example corresponds to Case 6, where lines #1, 4, 5 are assigned to customers #1, 2, 3 respectively. In other words, the optimal values for l₁, l₂ and l₃ in (1) are given by l₁=1, l₂=4, l₃=5. In this case it can be seen that the performance index (which represents the energy of the crosscoupling noise) for Case 6 is more than 22 times smaller than that of Case 1, where the POTS and DSL services are provided through the same line.

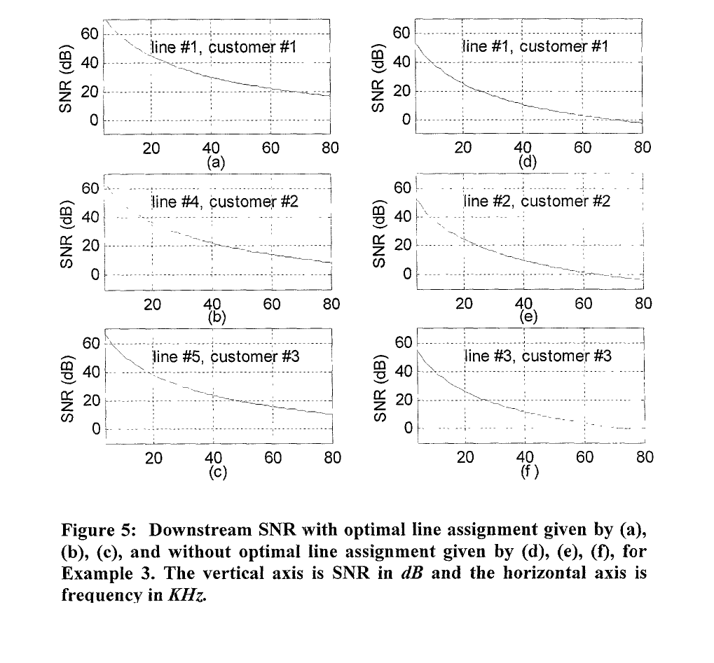

For comparison, the signal to noise ration (SNR) of the downstream data using the optimal line assignment (Case 6) and without using the optimal line assignment (Case 1), assuming that all transmission lines are 6 Km long with 26 gauge twisted pairs, and that ideal high-pass and low-pass filters of FIG. 1 are used for secure signal transmission, are given in FIG. 5.

Remark 2: In the examples studied, a relatively small number of lines and DSL customers is considered for simplicity. In actual practice, however, there can be as many as 100 lines in a cable, about 10 percent of which have DSL services assigned to them, and all lines are usually available for all customers in the neighborhood. Thus, the number of different combinations of size 10 (the number of DSL customers in the neighborhood) from a set of size 100 (the number of lines available to all DSL customers) would be

$${}_{100}^{}{C}{}_{10}^{} = \frac{100 !}{10 ! ( 100 - 10 ) !}$$

which makes the determination of the optimal line allocation unrealistic to compute. To avoid such an excessive amount of computation, one can however check a subset of lines in the binder, which will then provide a sub-optimal solution for the line assignment problem.

Remark 3: One can minimize the function defined in equation (1) in a general way, regardless of the DSL service-type, by choosing weighting matrices that are identity in a “reasonable” fixed frequency range such as f₁=4 KHz and f₂=1.5 MHz and zero elsewhere, and by setting U_{DSL,DN,k}=U_{DSL,UP,k}=1, k=1, . . . , m. This will simplify the optimization problem and since the NEXT transfer functions are more or less uniform (in terms of strength) in all frequency ranges, it will result in a sub-optimal solution to the noise reduction problem.

Remark 4: It is to be noted that using the proposed method, one can also use a single line to provide services for more than two customers. The only constraint required is that the frequency band of different customers who are sharing a line must be distinct. In this case, low-pass, band-pass and high-pass filters will be required to guarantee a secure signal transmission for all customers by preventing each customer from having access to the signal in the frequency band of the other customers' service. This procedure can be used to assign very high speed DSL service to customers who are very close to the CO and lower speed service for customers who are not too close, assuming that the corresponding line is proven to have weaker interaction with other lines in the network.

Remark 5: A similar idea can be used to minimize far end crosstalk (FEXT) effect in the relatively short lines or where FEXT affects the received signal. However, the effect of NEXT is usually dominant in lines longer than 1000 ft.

What is claimed is:

1. The idea of sharing a phone line (twisted pair) with more than one customer.

2. The idea of assigning lines to DSL customers in the network, independently of lines assigned to the POTS service of the corresponding customers.

3. Using the idea of claim 1 to increase the number of available lines for the customers of fat-pipe technology.

4. Using the ideas of claim 1 and claim 2 to improve the performance of the DSL network by reducing the effect of crosscoupling noise in the network and increasing the SNR of the DSL services.

5. Using the idea of claim 1 and claim 2 to solve any given optimization problem, such as the problem of minimizing the weighted sum of the energy of the crosscoupling between lines in the network or any other performance index, by finding the telephone lines that have minimum interaction with each other in the network and assigning them to the DSL services.

6. Using the optimization problem of claim 5 to improve SNR of the network or data transmission rate of the network.

7. Using the idea of claim 5 and 6 to prioritize different customers by assigning proper weighting function to different customers in the performance index.

8. Using the idea of claim 1 and claim 2 and simplifying the optimization problem of claim 5, by searching between a subset of available lines, instead of all available lines, for assigning to DSL service.

9. The method of claim 8 can be implemented, by identifying a subset of lines which have relatively weak interaction.

10. Identifying a subset of weakly interacting lines in claim 9 can be accomplished via direct measurement such as using a spectrum analyzer, or any identification procedure.

11. Using the idea of claim 1 and claim 2 to solve the optimization problem by taking the crosscoupling strength between all lines and the DSL service-type of each customer into account.

12. Using the idea of claim 1 and claim 2 to solve the optimization problem of claim 5 in a general way and independently of the service-type of each customer by finding the lines with minimum crosscoupling norm.

13. The idea of claim 1 and 2 can be implemented by using the bridged-taps, which exist at different locations throughout the line.

14. The idea of claim 1 and claim 2 can be used to assign one line to more than two customers, if the line is known to have small interaction with other lines at specific bridged-tap locations throughout the line.

15. The idea of claim 1, claim 2 and claim 14 can be applied to one POTS customer and multiple DSL customers with distinct data frequency band.

16. Using the idea of claim 14, if a line is assigned to multiple customers, the ones who are closer to the CO will receive a faster DSL service.

17. The ideas of claim 1, claim 2 and claim 14 can be implemented by using proper filters (low-pass, band-pass and high-pass) to each customer sharing a line, to allow only a specific frequency band being delivered to each customer for a secure signal transmission.

18. The ideas of claim 4, 5, 9, 10, 11, 12, 14 can be used for near end crosstalk (NEXT), or far end crosstalk (FEXT) of lines, the effect of NEXT, however is normally dominant.
